(19) United States
(12) Patent Application Publication
(10) Pub. No.: US 2005/0057947 A1
(43) Pub. Date: Mar. 17, 2005

(54) Optical fiber device for illuminating floral displays

(76) Inventor: Mathew J. Robertson, Andover, MN (US)

Correspondence Address: William Propp, Esq.;PMB1-245, 8205 Santa Monica Boulevard, West Hollywood, CA, 90046, US

(21) Appl. No.: 10/774,674

(22) Filed: Feb. 9, 2004

Related U.S. Application Data
(60) Provisional application No. 60/501,941, filed on Sep. 11, 2003.

(51) Int. Cl. F21S 4/00

(52) U.S. Cl. 362/565

(57) ABSTRACT

The optical fiber lighting device utilizes an array of optical fibers adjacent to a light emitting diode powered by a battery, all contained in a generally cylindrical container capped by a switch. The switch is designed to close a circuit powering the light emitting diode. The light emitted by the light emitting diode will be transmitted through the optical fibers to illuminate a flower display, such as a corsage, wristlet, boutonniere or floral bouquet.

### CROSS-REFERENCE TO RELATED APPLICATIONS

This application claims the benefit of priority of U.S. Provisional Patent Application Ser. No. 60/501,941 filed on Sep. 11, 2003, entitled “Optical Fiber Device For Illuminating Floral Displays”, having inventor Mathew J. Robertson.

### FIELD OF THE INVENTION

This invention relates to floral designs. In one of its more particular aspects the present invention relates to a device for illuminating floral displays.

In another of its more particular aspects the present invention relates to the use of optical fibers to provide lighting for flower displays, such as corsages, wristlets, boutonnieres, and bouquets.

### BACKGROUND OF THE INVENTION

The use of lights in various types of decorative displays is well known. For example, flashlights may have attachments, which are fitted upon the flashlight and illuminated by means of the flashlight beam. Neon lights are used in a variety of neon signs and other lighted displays. With the advent of optical fibers, various displays have featured the pinpricks of light produced by arrays of optical fibers.

It is an object of the present invention to provide an optical fiber lighting device, which can be used in flower displays.

Another object of this invention is to provide such a device, which can be incorporated into wearable fresh flower displays, such as corsages, wristlets, and boutonnieres.

Another object of the present invention is to provide an optical fiber lighting device, which is relatively lightweight.

Other objects and advantages of the present invention will become apparent from the following detailed disclosure and description.

### SUMMARY OF THE INVENTION

The optical fiber lighting device of the present invention utilizes an array of optical fibers adjacent to a light emitting diode powered by a battery, all contained in a generally cylindrical container capped by a switch. The switch is designed to close a circuit powering the light emitting diode upon rotation. The light emitted by the light emitting diode will be transmitted through the optical fibers to illuminate a flower display. The device is dimensioned and shaped to facilitate its employment in various types of floral displays, such as corsages, wristlets, and boutonnieres. It can also be used with floral bouquets, if desired.

### BRIEF DESCRIPTION OF THE DRAWING

The preferred embodiments of this invention will be described in detail, with reference to the following figures wherein:

FIG. 1 is a perspective view, partly in section, of the optical fiber lighting device of the present invention.

FIG. 2 is an enlarged front elevation of the cylinder container and switch of the optical fiber lighting device of FIG. 1, shown detached and with the battery removed.

FIG. 3 is a bottom view of the switch of the optical fiber lighting device of FIG. 1, partly in section.

FIG. 4 is a front elevation of the optical fiber lighting device of the present invention, partly in section.

FIG. 5 is a view similar to FIG. 4 showing the switch rotated towards the “ON” position.

FIG. 6 is a reduced size perspective view of the optical fiber lighting device of the present invention in use in a corsage flower display.

### DESCRIPTION OF THE PREFERRED EMBODIMENTS

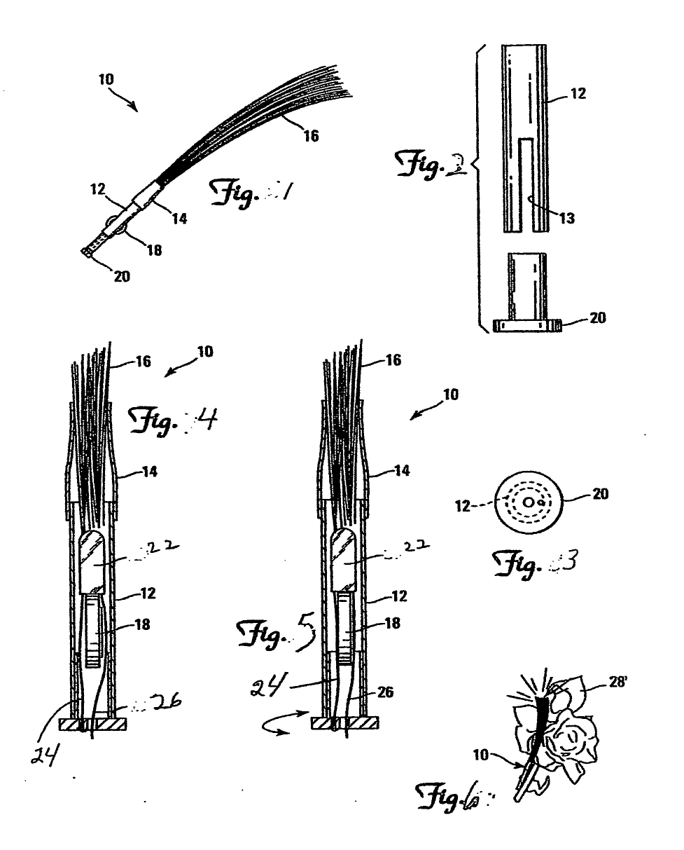

Referring to FIG. 1 of the drawing, optical fiber lighting device 10 is shown including a cylinder container 12 having an extension 14 for crimping an array of optical fibers 16. The crimping extension holds the array of optical fibers in position. Projecting through the wall of cylinder container 12 is a battery 18. A switch 20 caps the end of cylinder container 12.

FIG. 2 shows cylinder container 12 having a slot 13 for holding the battery in position.

FIG. 3 shows cylinder container 12 (in section) and two wire holes in the cylinder container end cap. The wires from the battery and the light emitting diode will extend through the holes in the end cap to the on/off switch.

In FIGS. 4 and 5, each of the elements shown in FIG. 1 is shown in relation to a light emitting diode 22 and wires 24 and 26. The wires 24 and 26 connect the light emitting diode 22 to the battery 18.

The wires are also connected to turning switch 20, as shown in FIG. 5, to turn on light emitting diode 22 by closing the circuit between the battery and the light emitting diode. The diode 22 will emit light when the switch is ON and the circuit is closed.

The array of optical fibers is positioned adjacent to the light emitting diode. The crimping extension holds the array of optical fibers in position. The light emitted by the light emitting diode is received by the optical fibers and transmitted through the optical fibers to be emitted and illuminate the flower display.

The use of these elements provides a lightweight lighting device, which can be incorporated into wearable fresh flower displays.

A corsage 28 is shown in FIG. 6 attached to the optical fiber lighting device 10 of the present invention. The optical fibers of the lighting device are among or adjacent to the flowers in the corsage to illuminate the flowers. As shown in the Figure, the lighting device of the corsage (or boutonniere) has a hook or other securing means to fasten the flower and lighting device to clothing.

The device is dimensioned and shaped to be used in corsages, wristlets, men's boutonnieres and floral bouquets.

It will be appreciated that the disclosure and description of the instant specification are set forth by way of illustration and not limitation, and that various modifications and changes may be made without departing from the spirit and scope of the present invention.

1. An optical fiber lighting device for a flower display comprising:
at least one flower in a flower display;
a lighting device having
a power source;
a light source driven by said power source to emit light; and
an array of optical fibers receiving light emitted by said light source, said array of optical fibers transmitting said light to illuminate said at least one flower.

2. The optical fiber lighting device for a flower display of claim 1 wherein said light source is a light emitting diode.

3. The optical fiber lighting device for a flower display of claim 1 further comprising:
a switch to turn said light source off and on.

4. The optical fiber lighting device for a flower display of claim 1 wherein said power source is at least one battery.

5. The optical fiber lighting device for a flower display of claim 1 wherein said flower display is a corsage.

6. The optical fiber lighting device for a flower display of claim 1 wherein said flower display is a wristlet.

7. The optical fiber lighting device for a flower display of claim 1 wherein said flower display is a boutonniere.

8. The optical fiber lighting device for a flower display of claim 1 wherein said flower display is a bouquet.

9. The optical fiber lighting device for a flower display of claim 1 further comprising securing means to fasten said lighting device and said at least one flower to clothing.

10. An optical fiber lighting device for a flower display comprising:
at least one flower in a flower display;
a lighting device having
at least one battery;
a light emitting diode driven by said at least one battery to emit light;
a switch to turn said light emitting diode off and on; and
an array of optical fibers receiving light emitted by said light emitting diode, said array of optical fibers transmitting said light to illuminate said at least one flower.

11. The optical fiber lighting device for a flower display of claim 10 wherein said flower display is a bouquet.

12. The optical fiber lighting device for a flower display of claim 10 further comprising securing means to fasten said lighting device and said at least one flower to clothing.

13. The optical fiber lighting device for a flower display of claim 12 wherein said flower display is a corsage.

14. The optical fiber lighting device for a flower display of claim 12 wherein said flower display is a wristlet.

15. The optical fiber lighting device for a flower display of claim 12 wherein said flower display is a boutonniere.
